(19) United States
(12) Patent Application Publication
(10) Pub. No.: US 2025/0327501 A1
(43) Pub. Date: Oct. 23, 2025

(54) CUP FOR PROTECTING A DROPPED PAYLOAD

(71) Applicant: Government of the United States as represented by the Secretary of the Air Force, Wright-Patterson AFB, OH (US)

(72) Inventors: Jason Christopher, USAFA, CO (US); Enrique Arjona, USAFA, CO (US); Michael Anderson, Colorado Springs, CO (US)

(21) Appl. No.: 18/638,139

(22) Filed: Apr. 17, 2024

(51) Int. Cl. F16F 9/04; F16F 9/10

(52) U.S. Cl. CPC F16F 9/049; F16F 9/10

(57) ABSTRACT

A cup for in combination with a parachute and used for absorbing shocks to a payload upon landing. The cup has a bottom to protect against vertical shock and an upstanding sidewall to protect against lateral shocks in any direction. The bottom has discrete contiguous tubes which may be pressurized for shock absorption or used to contain payload. The upstanding sidewall circumscribes the cup for protection in all directions against lateral impact. The upstanding sidewall has discrete contiguous chambers which may be pressurized for shock absorption. The bottom tubes and/or the sidewall chambers may be interconnected with contiguous tube or chambers, respectively by ports. The ports allow liquid to be pumped from one tube or chamber to an adjacent tube or chamber, respectively, to dissipate lateral or vertical energy from ground impact.

### STATEMENT OF GOVERNMENT INTEREST

The invention described and claimed herein may be manufactured, licensed and used by and for the Government of the United States of America for all government purposes without the payment of any royalty.

### FIELD OF THE INVENTION

The present invention is related to a cup for use in combination with a parachute to protect a payload from ground impact, more particularly to such a cup having a bottom with discrete tubes and a circumscribing sidewall with discrete chambers for protecting against vertical and lateral shocks.

### BACKGROUND OF THE INVENTION

The first recorded parachute jump preceded flying aircraft and occurred in 1797. Then Andre-Jacques Garnerin jumped from a hydrogen balloon 3000 feet above Paris, France using a circular silk canopy feet in diameter and attached to a basket with suspension lines.

Since that time parachutes have advanced to rectangular canopies and unmanned parachute descent. Unmanned parachutes are important for hostile applications where the mission needs to deliver a payload without endangering personnel. Unmanned parachutes typically carry a payload in a basket depending from the canopy by plural guy wires. Such unmanned parachutes may be remotely or autonomously steered towards a ground target as needed for the particular mission.

When the unmanned parachute lands at or near the target, shock to the basket, and ultimately the payload, inevitably occurs. The shock may be vertical as occurs when the basket lands directly on the bottom. But lateral motion inevitably occurs due to uncontrollable wind currents, etc. The lateral motion results in shock imparted to the sides of the basket in all lateral directions.

Efforts have been made to control shock in parachute descents. But most of these efforts are directed to the shock which occurs when the canopy opens and the guy wires are rapidly made taut. For example, more than 100 years ago U.S. Pat. No. 1,401,040 proposed a parachute having a safety spring or suspension as a shock absorbing device for making a descent from an aircraft by means of a parachute and consisting essentially of a resilient and extensible element mounted between the parachute and the passenger. But this attempt, and many of the subsequent attempts do not protect the payload from ground contact.

Accordingly, it is an object of this invention to provide a cup for protecting a parachute payload from ground impact upon landing and more particularly to protect the parachute payload from vertical impact, lateral impact and combinations thereof.

### SUMMARY OF THE INVENTION

In one embodiment the invention comprises a cup for dissipating shock to a payload and having a longitudinal axis defining a longitudinal direction. The cup is used in combination with a parachute and comprises a closed end bottom having a perimeter an outwardly facing bottom surface and an inwardly facing top surface opposed thereto, the closed end bottom having plural contiguous, sealed elongated tubes joined in lengthwise relationship; and a sidewall upstanding from the closed end bottom and having plural circumferentially spaced contiguous chambers the plural chambers defining an inner surface and an outer surface opposed thereto.

### BRIEF DESCRIPTION OF THE DRAWINGS

FIG. 1 is a schematic view of a steerable parachute and payload usable with the cup of the present invention, the cup being shown in phantom.

FIG. 2 is a schematic perspective view of a cup according to the present invention, shown partially in cutaway.

FIG. 3 is a scale exploded perspective view of a cup according to the present invention.

FIG. 4 is a scale perspective view of a sidewall usable with a cup of the present invention.

FIG. 5 is a scale perspective view of a bottom usable with a cup of the present invention.

FIG. 6 is a scale perspective view of an alternative embodiment of a bottom usable with a cup of the present invention.

FIG. 7A is a schematic perspective view of another alternative embodiment of a bottom usable with a cup of the present invention.

FIG. 7B is a front elevational view of the alternative embodiment of FIG. 7A.

FIG. 8 is a scale front elevational view of another alternative embodiment of a bottom usable with a cup of the present invention.

FIG. 9A is a scale perspective view of another alternative embodiment of a cup according to the present invention.

FIG. 9B is a schematic top plan view of a cup according to the alternative embodiment of FIG. 9A.

FIG. 10 is a schematic bottom plan view of an alternative bottom for the cup of the present invention.

### DETAILED DESCRIPTION OF THE INVENTION

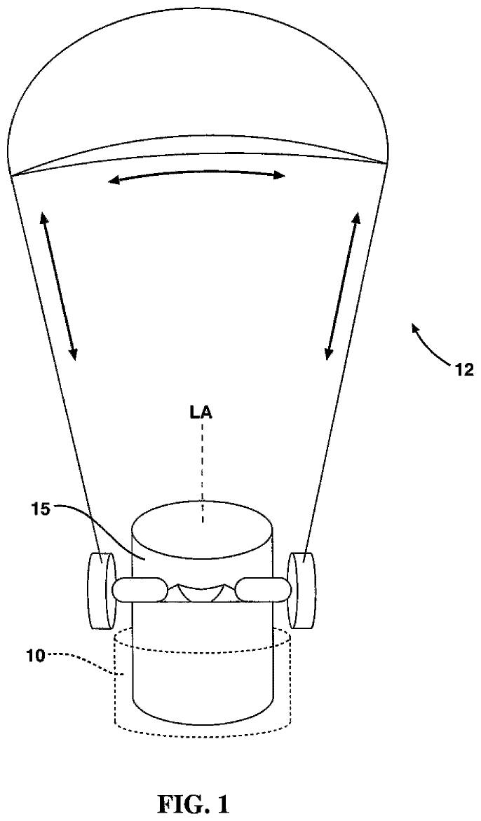

Referring to FIG. 1 the invention comprises a cup 10 in combination with a parachute 12. The parachute 12 comprises a canopy with a payload 15 depending therefrom by plural guy wires in known fashion. The payload 15, in turn, is protected from vertical and lateral ground shock by a cup 10. The cup 10 has a closed end bottom 20 and a sidewall 30 upstanding from the bottom 20. The parachute 12 and cup 10 have a central longitudinal axis LA and may be concentric thereabout. The longitudinal axis LA is vertical as shown in the figures. The particular parachute 12 and payload 15 form no part of the claimed invention except as may be specifically claimed below.

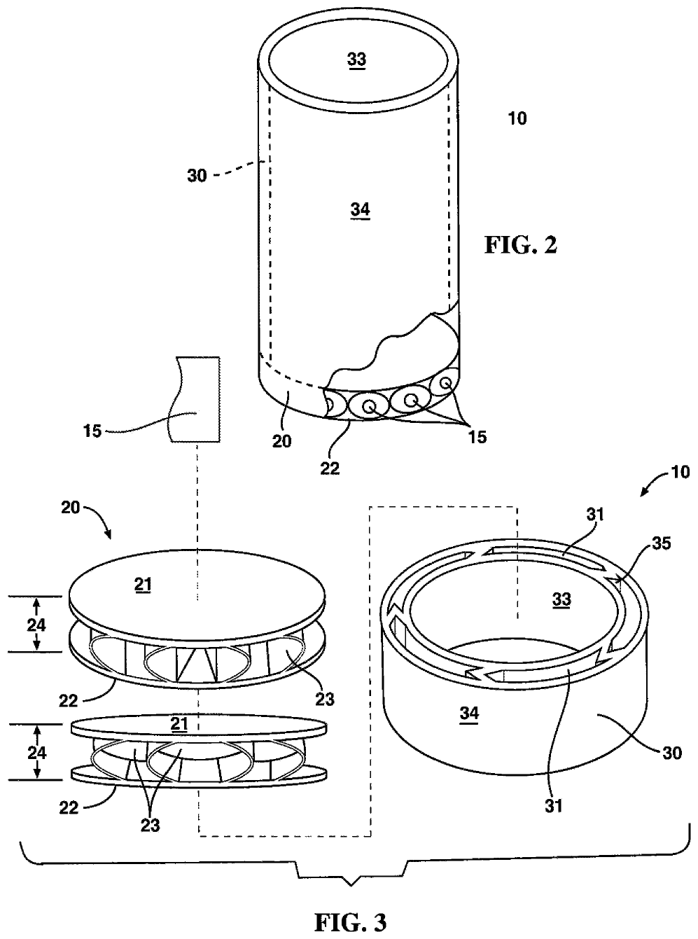

Referring to FIG. 2 and examining the invention in more detail, the bottom 20 of the cup 10 has a perimeter, which is preferably circular. The bottom 20 has an outwardly facing bottom surface 22 and an inwardly facing top surface 21 opposed to the bottom surface 22. The bottom 20 has plural tubes 23 which may be used to contain payload 15. A sidewall 30 is upstanding from the bottom 20. The sidewall 30 preferably circumscribes the payload 15. The sidewall 30 has plural circumferentially spaced chambers 31. The sidewall 30 has an inner surface 33 facing towards the longitudinal axis LA and an outwardly facing surface opposed thereto.

The tubes 23 may be closed and pressurized with a gas 41 to store and release energy or may simply be maintained at atmospheric pressure. Different tubes 23 may be equally pressurized for simplicity. Alternatively, different tubes 23 may have mutually different pressures therein to provide different spring constant for advantageously absorbing different shock levels upon ground contact.

If desired, the tubes 23 may be loaded with payload 15. Payload 15 may include any supplies, provisions, munitions, etc. which are helpful for the mission and fit inside the tubes 23. Optionally, the ends of the tubes 23 may be sealed to increase the spring constant and provide further shock resistance to impact. After the payload 15 is recovered from the ground target the ends of the tubes 23 may be opened and the payload 15 recovered.

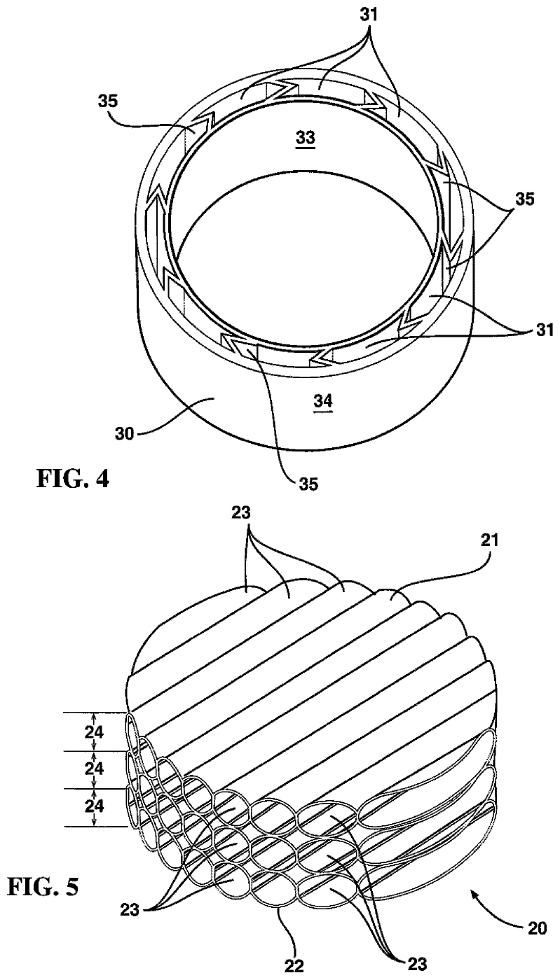

Referring to FIG. 3 and FIG. 4, the sidewall 30, may be thought of as having plural springs 35. As shown, the chambers 31 of the sidewall 30 preferably circumscribe the cup 10 to protect the payload 15. The chambers 31 of the sidewall 30 may be defined by the inner surface 33, the outer surface 34 and generally radially oriented chevron springs 35 separating adjacent chambers 31. While only a single annulus of chevrons is shown, on of skill will recognize that plural rings of chambers 31 may be radially stacked against one another. Similarly, the chambers 31 need not be vertically oriented, but may have walls defining and separating adjacent chambers 31 which are oriented 45+/−15 degrees relative to the longitudinal axis LA.

Referring to FIG. 3 and FIG. 5, the tubes 23 may be contiguous, mutually parallel and disposed in one layer 24 and preferably plural layers 24. The layers 24 may be mutually parallel and of different thicknesses or preferably be the same thickness in the longitudinal direction parallel to the longitudinal axis LA. The walls of the tubes 23 may be chevron shaped, as shown, for resiliency upon deflection caused by ground impact. The chevron shaped walls may point in the same direction or in opposite directions. The tubes 23 may be thought of as springs 35 in parallel in each layer 24 and the layers 24 as springs 35 in series, with each such series spring 35 composed of plural parallel springs 35.

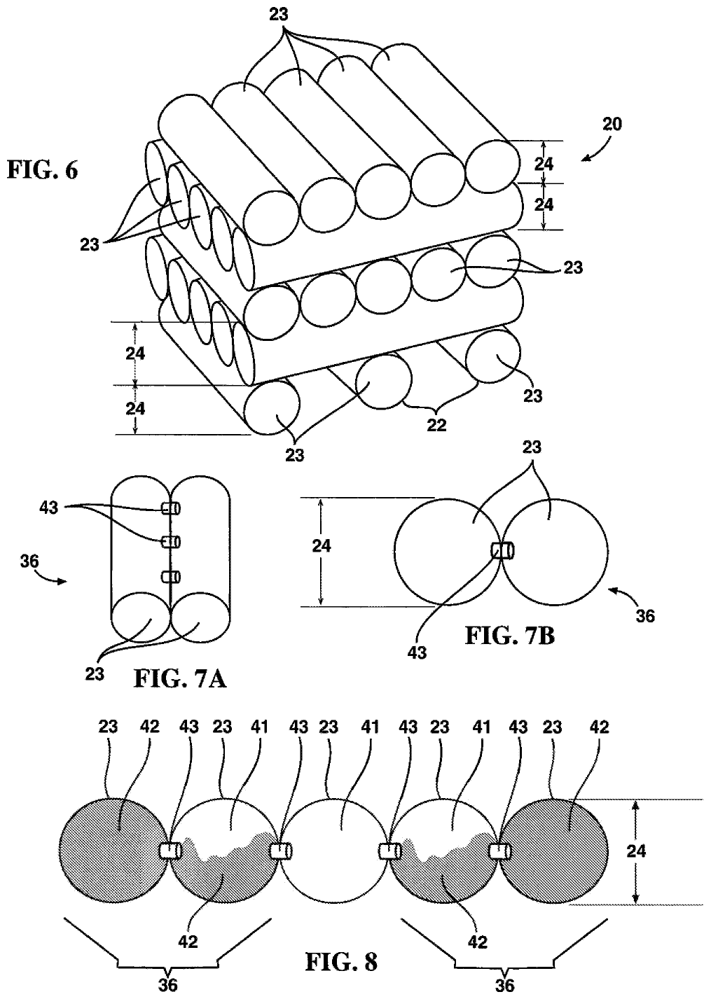

Referring to FIG. 6, in an alternative embodiment the bottom 20 of the cup 10 may have layers 24 of tubes 23 which are skewed relative to, and preferably perpendicular to, tubes 23 in the subjacent and/or superjacent layers 24. This arrangement provides the benefit of protecting against the inevitable oblique impacts against uneven surfaces, rocks, debris on the ground, etc. The tubes 23 in this embodiment, or any embodiment herein, may be equally or unequally spaced within or between layers 24. The tubes 23 in a particular layer 24 are preferably equally sized for simplicity, but tubes 23 in different layers 24 may be differently sized and/or different in the number, stiffness and even length of tubes 23 in other layers 24.

While a cylindrical cup 10 is preferred for oblique deflection of lateral impacts, one of skill will recognize the invention is not so limited. The cup 10 may be parallelepipedally shaped, based upon the needed length of multiple tubes 23, hourglass shaped to promote deflection from vertical impact, tapered for aerodynamics, etc.

Referring to FIG. 7A and FIG. 7B, if desired, the tubes 23 may be used as pumps 36 instead of or in addition to the tubes 23 which are used as springs 35. In this arrangement, one tube 23 may be charged or even filled with a liquid 42. The liquid 42 may be water, oil, silicone emulsions, etc. and combinations thereof. The liquid 42 may have a viscosity of 0.1 to 65 cps as measured according to ISO TR 3666-1998. In this embodiment, adjacent tubes 23 are connected by one or more ports 43. The ports 43 may have a cross sectional area of 0.5 to 10 square millimeters.

Upon impact liquid 42 is squeezed from a first tube 23 through one or more ports 43 into a second tube. The one or more pumps 36 used with a cup 10 of the present invention provides the benefit that energy is dissipated by the pumping action, rather than stored and released as occurs with the aforementioned springs 35.

Referring to FIG. 8, the pump 36 may comprise plural banks of tubes 23 acting together. Depending upon the force and deceleration of the impact, compression of tubes 23 having more liquid 42 thereon may force that liquid 42 to tubes 23 having less or no liquid 42 due to the effect of incompressible liquids 42 flowing from high pressure to low pressure. In this exemplary and nonlimiting example, two pumps 36 may be used in parallel with a layer 24 having five tubes 23. The two outermost tubes 23 may be filled with a liquid 42. The two corresponding adjacent, intermediate tube 23 may be connected with the respective outer tubes 23 by ports 43 and filled with a liquid 42 and gas 41 mixture. The central tube 23 may be filled with a compressible gas 41 and connected by ports 43 to both intermediate tubes 23. Upon vertical impact, liquid 42 is squeezed from each of the outer tubes 23 through the ports 43 to the respective adjacent intermediate tubes 23. Liquid 42 originally charged into the intermediate tubes 23 or added thereto by displacement from the outer tubes 23 can then flow through respective ports 43 into the central tube.

This arrangement provides the benefit that mutually opposed liquid 42 flows from the outer tubes 23, to and through the respective intermediate tubes 23 and, in cases of sever shock into the central tube 23 from opposite directions. The mutually opposed gas 41 flows and liquid 42 flows superimpose to offset lateral imbalances.

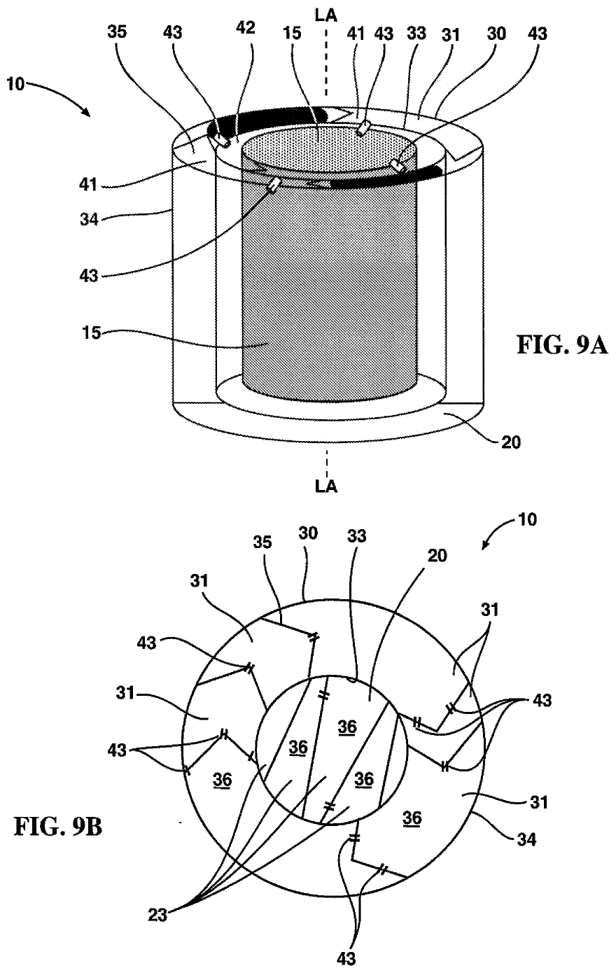

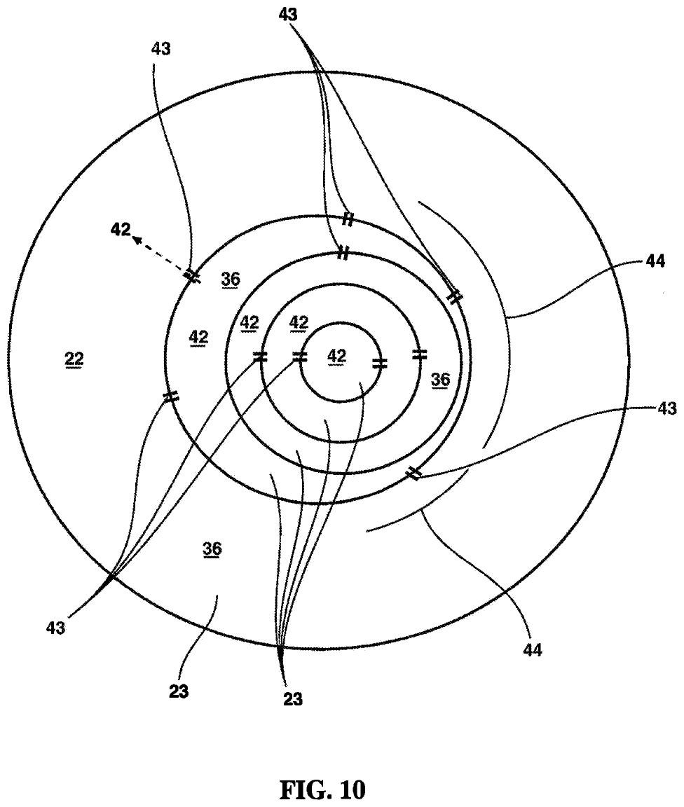

Referring to FIG. 9A and FIG. 9B, in another embodiment, the circumferentially curvilinear chambers 31 of the sidewall 30 may also comprise individual pumps 36. The chambers 31 may contain gas 41, liquid 42 or a combination thereof. Adjacent circumferentially spaced chambers 31 may be connected by one or more longitudinally spaced ports 43. The ports 43 may be longitudinally spaced neat the bottom of the chambers 31 to effectuate advantageous pump action. If desired, the chambers may have check valves to prevent reverse flow.

As lateral impact occurs, liquid 42 is pumped from the chamber 31 most affected into through the ports 43 into one or both of the adjacent chambers 31. The ports 43 may be constructed in known fashion to allow flow in only one circumferential direction to a single adjacent chamber 31 or preferably in opposed circumferential directions into two adjacent chambers 31.

The cup 10 may have from 2 to 16, and preferably 8 to 12, chambers 31 spaced about the longitudinal axis LA. In one particular case the cup 10 may have four chambers 31 circumscribing the longitudinal axis LA, with each chamber 31 subtending 90 degrees, although it will be understood that a cup 10 having 3 chambers 31 with each chamber 31 subtending 120 degrees, 2 chambers 31 three chambers 31 with each chamber 31 subtending 180 degrees, 12 chambers 31 with each chamber 31 subtending 30 degrees, etc. are likewise feasible and contemplated.

The chambers 31 may be equally sized or unequally sized as shown. Similarly, the tubes 23 of the bottom 20 may be tapered perpendicular to the longitudinal axis LA for nesting and to accommodate different payload 15 geometries.

Referring to FIG. 10, in an alternative embodiment the bottom 20 of the cup 10 may comprise annular tubes 23. The tubes 23 may be concentric, eccentric or a combination thereof as shown. The tubes 23 may be filled with liquid 42, gas 41 or a combination thereof. If desired, one or more radially adjacent tubes 23 may be connected by ports 43. Liquid 42 filled tubes 23 may, as described above, perform as pumps to dissipate energy from the vertical impact by pumping the liquid 42 radially inward or outward to a contiguous annular tube.

One or more of the tubes 23 may comprise baffles 44. The baffles 44 are juxtaposed with, and preferably aligned with, the ports 43. The baffles 44 impede flow of liquid 42 into the corresponding chamber, thereby dissipating more energy than would occur without the baffles 44 being in place.

All values disclosed herein are not strictly limited to the exact numerical values recited. Unless otherwise specified, each such dimension is intended to mean both the recited value and a functionally equivalent range surrounding that value. For example, a dimension disclosed as “40 mm” is intended to mean “about 40 mm.” Various alternative embodiments may be used individually or in combination. The term “or” as used herein is to be interpreted as an inclusive or meaning any one or any combination. Therefore, “A, B or C” means “any of the following: A; B; C; A and B; A and C; B and C; A, B and C.” Every document cited herein, including any cross referenced or related patent or application, is hereby incorporated herein by reference in its entirety unless expressly excluded or otherwise limited. The citation of any document or commercially available component is not an admission that such document or component is prior art with respect to any invention disclosed or claimed herein or that alone, or in any combination with any other document or component, teaches, suggests or discloses any such invention. Further, to the extent that any meaning or definition of a term in this document conflicts with any meaning or definition of the same term in a document incorporated by reference, the meaning or definition assigned to that term in this document shall govern according to Phillips v. AWH Corp., 415 F.3d 1303 (Fed. Cir. 2005). All limits shown herein as defining a range may be used with any other limit defining a range of that same parameter. That is the upper limit of one range may be used with the lower limit of another range for the same parameter, and vice versa. As used herein, when two components are joined or connected the components may be interchangeably contiguously joined together or connected with an intervening element therebetween. A component joined to the distal end of another component may be juxtaposed with or joined at the distal end thereof. While particular embodiments of the present invention have been illustrated and described, it would be obvious to those skilled in the art that various other changes and modifications can be made without departing from the spirit and scope of the invention and that various embodiments described herein may be used in any combination or combinations. It is therefore intended the appended claims cover all such changes and modifications that are within the scope of this invention.

What is claimed is:

1. A cup for dissipating shock to a payload and having a longitudinal axis defining a longitudinal direction, the cup in combination with a parachute and comprising:
a closed end bottom having a perimeter, an outwardly facing bottom surface and an inwardly facing top surface opposed thereto, the closed end bottom having plural contiguous, sealed elongate tubes joined in lengthwise relationship; and
a sidewall upstanding from the closed end bottom and having plural circumferentially spaced contiguous chambers the plural chambers defining an inner surface and an outer surface opposed thereto.

2. A cup according to claim 1 wherein the plural tubes are mutually parallel and define a layer of tubes.

3. A cup according to claim 2 further comprising plural layers of longitudinally stacked mutually parallel contiguous, sealed elongate tubes.

4. A cup according to 3 wherein adjacent layers have tubes disposed in mutually perpendicular directions.

5. A cup according to claim 2 wherein at least two of the plural tubes are pressurized with a gas.

6. A cup according to claim 3 wherein all of the plural tubes are pressurized with a gas, the tubes having at least two mutually different pressures therein.

7. A cup for dissipating shock to a payload and having a longitudinal axis defining a longitudinal direction, the cup in combination with a parachute and comprising:
a closed end bottom having a perimeter an outwardly facing bottom surface and an inwardly facing top surface opposed thereto, the closed end bottom having a plurality of adjacent longitudinally stacked layers, each layer comprising a plural contiguous, sealed elongate tubes joined in lengthwise relationship; and
a sidewall upstanding from and circumscribing the closed end bottom and having plural circumferentially spaced contiguous chambers the plural chambers defining an inner surface and an outer surface opposed thereto.

8. A cup according to claim 7 having a bottom layer of plural tubes wherein at least a first tube and a second tubes are in mutual fluid communication, the first tube further comprising a liquid therein, whereupon the liquid pumps from the first tube to the second tube in response to longitudinal impact on the outwardly facing bottom surface.

9. A cup according to claim 7 wherein each of the first tube and the second tubes having are contiguous and annularly shaped, the first tube and the second tube having a port fluidly connecting the first tube and the second tube to thereby pump liquid from the first tube to the second tube in response to the longitudinal impact.

10. A cup according to claim 9 wherein the ports have an area ranging from 0.5 sq. mm to 10 sq. mm and the liquid has a viscosity ranging from 0.1 cps to 65 cps.

11. A cup according to claim 7 having from 2 to 16 circumferentially spaced chambers circumscribing the perimeter of the bottom of the cup.

12. A cup according to claim 11 wherein at least four chambers circumferentially spaced 90 degrees out are pressurized with a fluid.

13. A cup according to claim 11 having at least four pairs of chambers circumferentially spaced 90 degrees out, each pair of chambers having a liquid filled chamber and a contiguous receiving chamber in fluid communication therewith whereby liquid from a liquid filled chamber is pumped from a liquid filled chamber to a respective contiguous receiving chamber in response to lateral impact of the corresponding liquid filled chamber.

14. A cup according to claim 13 wherein the liquid filled chamber and the contiguous receiving chamber are fluidly connected by a port therebetween, the port being disposed longitudinally below the midpoint of the chamber.

15. A cup according to claim 14 wherein the chambers are oriented 45+/−15 degrees relative to the longitudinal axis.

16. A cup in combination with a parachute and for dissipating shock to a payload and having a longitudinal axis defining a longitudinal direction, the cup comprising:
a closed end bottom having a perimeter an outwardly facing bottom surface and an inwardly facing top surface opposed thereto, the closed end bottom having a plurality of adjacent longitudinally stacked layers, each layer comprising a plural contiguous, sealed elongate tubes joined in lengthwise relationship; and
a sidewall upstanding from the closed end bottom and having plural circumferentially spaced contiguous chambers the plural chambers defining an inner surface and an outer surface opposed thereto, the chambers having a spring therein and radially biasing the inner surface and outer surface away from each other in the radial direction, the spring compressing radially in response to lateral impact to the sidewall.

17. A cup according to claim 16 wherein the springs are chevron shaped.

18. A cup according to claim 16 wherein the chambers are oriented within +/−15 degrees of parallel to the longitudinal axis and circumferentially spaced apart from adjacent chambers.

19. A cup according to claim 16 wherein at least one layer of the plurality of layers has parallel elongate tubes of mutually different sizes.

20. A cup according to claim 19 having a bottom layer, a superjacent layer and at least one other layer longitudinally stacked thereon, at least one of the superjacent layer and other layer stacked therein further comprising a payload in at least some of the tubes thereof.
